(19) United States
(12) Patent Application Publication
(10) Pub. No.: US 2024/0127197 A1
(43) Pub. Date: Apr. 18, 2024

(54) Predictive Maintenance Scheduler and Method

(71) Applicant: Georgia Tech Research Corporation, Atlanta, GA (US)

(72) Inventors: David Alvord, Smyrna, GA (US); Andrew Harper, Atlanta, GA (US); Anne Clark, Atlanta, GA (US); Nathaniel Thompson, Atlanta, GA (US); AnnMarie Spexet, Atlanta, GA (US)

(21) Appl. No.: 18/485,245

(22) Filed: Oct. 11, 2023

Related U.S. Application Data
(60) Provisional application No. 63/414,941, filed on Oct. 11, 2022.

(51) Int. Cl. G06Q 10/20; B64F 5/40; G06Q 10/0631; G06Q 50/06

(52) U.S. Cl. CPC G06Q 10/20; B64F 5/40; G06Q 10/06312; G06Q 50/06

(57) ABSTRACT

An exemplary scheduling optimization tool and method are disclosed that can determine optimally scheduled predictive maintenance actions during regularly scheduled inspection or operation periods, e.g., for tire replacement or maintenance or for fuel purchases, to improve logistical operations at a military base while maintaining mission readiness.

### RELATED APPLICATION

This application claims priority to, and the benefit of, U.S. Provisional Patent Application No. 63/414,941, filed Oct. 11, 2022, which is incorporated by reference herein in its entirety.

### BACKGROUND

Predictive maintenance can determine the condition of in-service equipment in order to estimate when maintenance should be performed. This approach can provide cost savings over routine or time-based preventive maintenance because tasks are performed when warranted. Predictive Maintenance operations are often overlooked due to resource-limited action personnel and organizations already overwhelmed with addressing active maintenance concerns in real time.

There is a benefit to improving predicted maintenance for optimization and scheduling.

### SUMMARY

An exemplary scheduling optimization tool and method are disclosed that can determine optimally scheduled predictive maintenance (PMx) actions during regularly scheduled inspection or operation periods, e.g., for tire replacement or maintenance or for fuel purchases, to improve logistical operations at a military base while maintaining mission readiness.

In some embodiments, the exemplary scheduling optimization tool and method provides an interface, e.g., a web application interface, that can operate with edge/cloud compute logistics optimization and real-time location data to provide digital fuel ordering and prediction, via machine learning operations, of reliable wait times for fuel trucks. The interface can provide tracking on operational information on delivery status and usable information on flight schedule as well as predictive analysis on driver schedule that accounts for no-shows to support multiple fuel trucks operations.

The exemplary scheduling optimization tool and method employ a modular data pipeline to operationalize data analytics research targeting Predictive Maintenance(PMx), Contested Logistics and related mission readiness applications.

In an aspect, a system is disclosed comprising: a predictive maintenance engine having instructions to execute: a dataset ingestion module configured to receive and to format data from a database, including an aircraft fuel order for a fuel delivery; a trained neural network configured to determine a predicted wait time for a set of aircraft fuel trucks based on the aircraft fuel order; and an order interface configured to display the predicted wait time for each of the set of aircraft fuel trucks.

In some embodiments, the system further includes a geofencing analysis module configured to determine a start fueling time and stop fueling time for a given fuel delivery order, wherein the start fueling time and stop fueling time are used to update, via a re-training operation, weights of the trained neural network.

In some embodiments, the aircraft fuel order includes order information comprising an order time submitted, a requested fuel type, a requested fuel quantity, an aircraft identifier, and a truck GPS location, wherein the order information is provided to an input layer of the trained neural network.

In some embodiments, the trained neural network was trained via a training data set comprising a set of transaction, each transaction comprising: order time information, requested fuel type, requested fuel quantity, aircraft identifier, and truck GPS location.

In some embodiments, the system further includes a scheduler configured to match, via a solver, an available fuel delivery truck to a set of aircraft fuel orders, including the aircraft fuel order, the scheduler is configured to generate an indication in the order interface of a recommended available fuel delivery truck for the aircraft fuel order.

In some embodiments, the scheduler is configured to generate an updated schedule for the set of aircraft fuel orders, the scheduler is configured to generate an indication in the order interface of recommended modification to existing aircraft fuel orders.

In some embodiments, the trained neural network is based on a deep neural network.

In an aspect, a method is disclosed comprising: receiving and formatting data, in a dataset ingestion operation, from a database, the data including an aircraft fuel order for a fuel delivery from a set of aircraft fuel trucks; determining, via a trained neural network, predicted wait time value for a set of aircraft fuel trucks based on the aircraft fuel order; and display, via an order interface for the aircraft fuel order the predicted wait time for the set of aircraft fuel trucks.

In some embodiments, the method further includes determining, via a geofencing operation, start fueling time and stop fueling time for a given fuel delivery order; and updating, via a re-training operation, weights of the trained neural network using the start fueling time and stop fueling time.

In some embodiments, the aircraft fuel order includes order information comprising an order time submitted, a requested fuel type, a requested fuel quantity, an aircraft identifier, and a truck GPS location, wherein the order information are provided to an input layer of the trained neural network.

In some embodiments, the method further includes training a neural network to generate the trained neural network, wherein the training was performed using a training data set comprising a set of transactions, each transaction comprising: order time information, requested fuel type, requested fuel quantity, aircraft identifier, and truck GPS location.

In some embodiments, the method includes matching, via a scheduler, an available fuel delivery truck to a set of aircraft fuel orders, including the aircraft fuel order; and generating, via a user interface, an indication of a recommended available fuel delivery truck for the aircraft fuel order.

In some embodiments, the scheduler is configured to generate an updated schedule for the set of aircraft fuel orders, the scheduler is configured to generate an indication in the order interface of recommended modification to existing aircraft fuel orders.

In some embodiments, the trained neural network is based on a deep neural network.

In another aspect, a non-transitory computer readable medium is disclosed having instructions stored thereon, wherein execution of the instructions by a processor causes the processor to execute: a dataset ingestion module configured to receive and to format data from a database, including an aircraft fuel order for a fuel delivery; a trained neural network configured to determine a predicted wait time for a set of aircraft fuel trucks based on the aircraft fuel order; and an order interface configured to display the predicted wait time for each of the set of aircraft fuel trucks.

In some embodiments, execution of the instructions by the processor further causes the processor to execute a geofencing analysis module configured to determine a start fueling time and stop fueling time for a given fuel delivery order, wherein the start fueling time and stop fueling time are used to update, via a re-training operation, weights of the trained neural network.

In some embodiments, the aircraft fuel order includes order information comprising an order time submitted, a requested fuel type, a requested fuel quantity, an aircraft identifier, and a truck GPS location, wherein the order information are provided to an input layer of the trained neural network.

In some embodiments, the trained neural network was trained via a training data set comprising a set of transactions, each transaction comprising: order time information, requested fuel type, requested fuel quantity, aircraft identifier, and truck GPS location.

In some embodiments, execution of the instructions by the processor further causes the processor to execute a scheduler configured to match, via a solver, an available fuel delivery truck to a set of aircraft fuel orders, including the aircraft fuel order, the scheduler is configured to generate an indication in the order interface of a recommended available fuel delivery truck for the aircraft fuel order.

In some embodiments, the scheduler is configured to generate an updated schedule for the set of aircraft fuel orders, the scheduler being configured to generate an indication in the order interface of recommended modification to existing aircraft fuel orders.

### BRIEF DESCRIPTION OF THE DRAWINGS

The accompanying drawings, which are incorporated in and constitute a part of this specification, illustrate embodiments and, together with the description, serve to explain the principles of the methods and systems.

FIG. 1 shows an example recommendation and tracking system and associated method for fuel ordering, scheduling, delivery, and tracking for aircrafts in accordance with an illustrative embodiment.

FIG. 2 shows an operational workflow of the logistical and predictive maintenance engine in accordance with an illustrative embodiment.

FIG. 3A shows a schedule (e.g., 106) configured to identify an available resource (e.g., fuel delivery slot or time) and associated available fuel delivery truck (and/or personnel) in accordance with an illustrative embodiment.

FIG. 3B shows an example neural network that can be configured as a wait time predictor module (e.g., 104) in accordance with an illustrative embodiment.

FIGS. 4A-4D show example visualizations for fuel delivery portal employing the predictive maintenance features described herein in accordance with an illustrative embodiment.

FIGS. 5A-5C show program details on an aircraft refueling truck logistical operation that is based on predictive maintenance models in accordance with an illustrative embodiment.

FIGS. 6A-6C show program details on the tire wear predictive maintenance operation in accordance with an illustrative embodiment.

FIGS. 7 shows a PostGres Table for a ReMAP's DSS for Aircraft Maintenance Planning Optimization (AMPO) in accordance with an illustrative embodiment.

### DETAILED SPECIFICATION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the reference list. For example, Ref. [1] refers to the 1^{st} reference in the list. All references cited and discussed in this specification are incorporated herein by reference in their entirety and to the same extent as if each reference was individually incorporated by reference.

### Example System

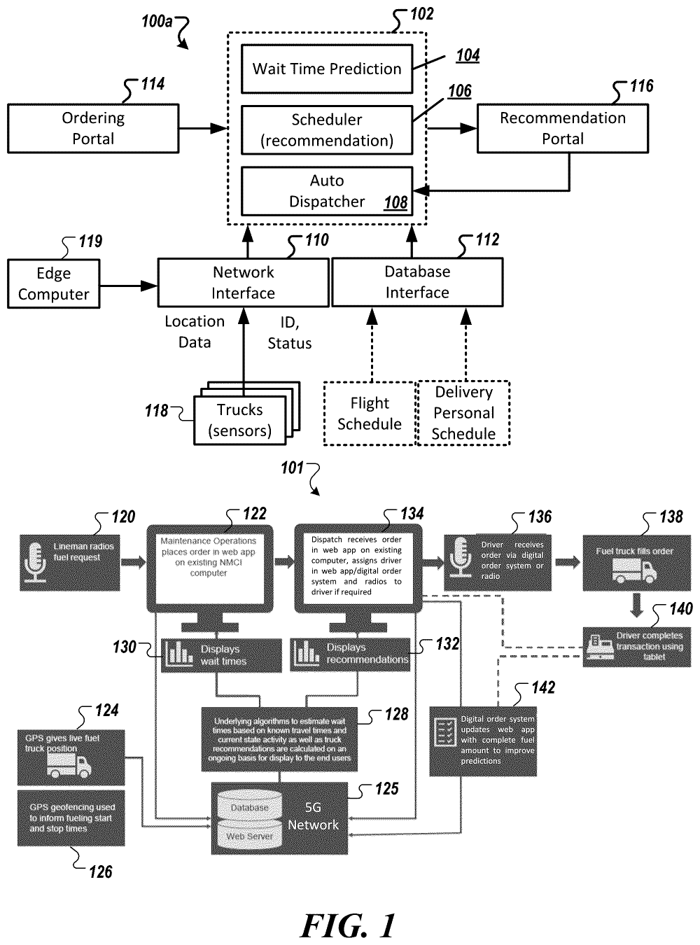

FIG. 1 shows an example recommendation and tracking system 100 (shown as 100a) and associated method 101 for fuel ordering, scheduling, delivery, and tracking for aircrafts. The system 100a includes a logistical and predictive maintenance engine 102 comprising a wait time prediction module 104, scheduler 106 comprising a predictive scheduler, and a dispatcher 108. The logistical and predictive maintenance engine 102 interfaces with a network interface 110, database interface 112, an ordering portal 114, and a recommendation portal 116.

The logistical and predictive maintenance engine 102 is configured to receive fuel order from ordering portal 114, predictively estimate the availability of a fuel truck and personnel and the estimated time to fulfill that order via a wait-time prediction module 104, and match a fuel truck and personnel with an order via the recommender 106. The recommendation is presented on a recommendation portal 116 to receive the instructions for the matching by the operator. The logistical and predictive maintenance engine 102 then directs the dispatching of order for the fuel truck and driver at the allocated time.

The logistical and predictive maintenance engine 102 may be implemented in a container, e.g., docker, Kubernetes, rancher using Python for algorithm execution and data pre-processing. Orchestration of the logistical predictive maintenance engine 102 may employ shell scripting via Apache airflow, Kubeflow, or Pachydern, among others.

Wait time prediction module 104, in some embodiments, is a trained neural network configured to generate a predicted wait time for a fuel truck. The Wait time prediction module 104 may be trained using historical data for the number of orders placed for given day in a week for a logistical site, e.g., military base. The estimated wait time, via the trained neural network, could account for known travel time and current state activity of the truck and specific delivery personnel.

Scheduler 106 includes a predictive scheduler that is configured to match available resource with a request. The scheduler 106 is preferably a solver based optimizer. In the example of FIG. 1, the scheduler 106 is configured to match the available resource to a request. The available resource may be defined as assignable trucks, current truck fuel amount, truck location, available start time, available end time. The request may be defined as request identifier, time submitted, fuel type, fuel amount requested, aircraft identifier (e.g., tail number), fleet identifier (e.g., squadron id.), user identifier, and truck GPS location. The output of the optimizer can be provided as a recommendation that can be indicated to the user.

Dispatcher 108 includes both manual dispatcher (personnel) and automated dispatcher. Manual dispatcher can take a given assignment fuel delivery task and reach out to the truck driver, e.g., via radio communication, with the given order. An auto dispatcher can perform the same task and provide a push notification of a fuel delivery order to the edge computing device (e.g., 119) associated with the truck driver.

Network interface 110 is configured to provide interface to IoT sensors or devices, e.g., over 5G network, to retrieve current truck GPS locations/coordinates from trucks 118. The network interface 110 may also interface with a remote computer (e.g., tablet) 119 executing a fuel application that records a refueling transaction.

Database interface 112 is configured to retrieve data from an external data store, e.g., having flight schedule data and delivery personnel schedule. The retrieved data can be correlated with the work flow data to allow for metric evaluation and searching.

Ordering portal 114 includes fuel delivery order form for a given fuel delivery order. The form can include a request type (e.g., fuel request or defuel request), the requester info (e.g., name, contact information, squadron info), the order details (e.g., modex value, fuel type, estimate fuel amount), and time for the delivery (e.g., time to take off or time of day). The ordering portal 114 can be web-based or an enterprise software system.

Recommendation portal 116 includes the fuel delivery order form with determined recommendation (e.g., from scheduler 106) or a second fuel request order form with the fuel delivery information. The recommendation portal 116 can display the current fuel delivery assignment, the new assignment based on the provided request, as well as existing assigned request information. The new assignment panel allows a truck number to be selected and assigned. The recommendation feature can indicate, via visual elements on the portal (e.g., highlighting, coloring, etc.), trucks that may be recommended or not recommended per the scheduler's determination. In some embodiments, the recommendation feature can indicate, via visual elements on the portal (e.g., highlighting, coloring, etc.), existing assignments that could be modified and/or reassigned. Recommendation portal 116 can be implemented via PowerBI, Tableau, or customized to display, such as via a web-based interface or via an enterprise software system.

### Example Method of Operation

Referring still to FIG. 1, the method of operation 101 is initiated with a fuel request being placed (120) by a lineman servicing an aircraft (shown as “Lineman radios fuel request” 120) directly or indirectly to the ordering portal 114. In the example shown in FIG. 1, the request is provided to the maintenance operator who then places (122) the order in the ordering portal 114. The request may include aircraft identifier (e.g., tail number) and associated squadron, fuel amount requested, fuel type, and the location of delivery. The maintenance operator can provide the request information and additionally, a request number, time of submission, requester identifier, and a preferred delivery (optional). In some embodiments, the request number and time of submission can be generated internally by the ordering portal 114.

The system 100a operates with a 5G network 125 that is configured to receive (124) truck GPS coordinates/locations from GPS/IoT sensor(s) located on the trucks. The GPS coordinates/location can be geofenced (126), e.g., via the logistical and predictive maintenance engine 102, to determine the start and stop times of fueling operation. The start and stop times can be stored for metric evaluation as well as for re-training updates to the trained neural network of the wait time prediction module 104.

Using the aircraft identifier (e.g., tail number), squadron identifier, fuel amount requested, fuel type, and location of delivery, the trained neural network is configured to generate (128) the estimated wait time for the fuel delivery. The predicted wait time and associated truck is presented (130) to the maintenance operator via the ordering portal 114 for the available trucks 118. The ordering portal 114 may present (130) options for all of the delivery trucks 118 meeting the fuel requirements that is selectable to the maintenance operator, along with the predicted wait time. The ordering portal 114 may indicate (132) one or more of the fuel delivery options, as a recommendation, based on a generated schedule, e.g., via the scheduler 106. The order portal 114 receives (134) a selection by the maintenance operator and provide a request to the dispatcher. The dispatcher, via a dispatch interface, assigns (136) a driver and truck and the dispatch is sent in. In some embodiments, the dispatcher radios the driver the order. The truck driver then delivers (138) the fuel and the driver completes (140) the transaction via a networked computing device, e.g., ruggedized tablet.

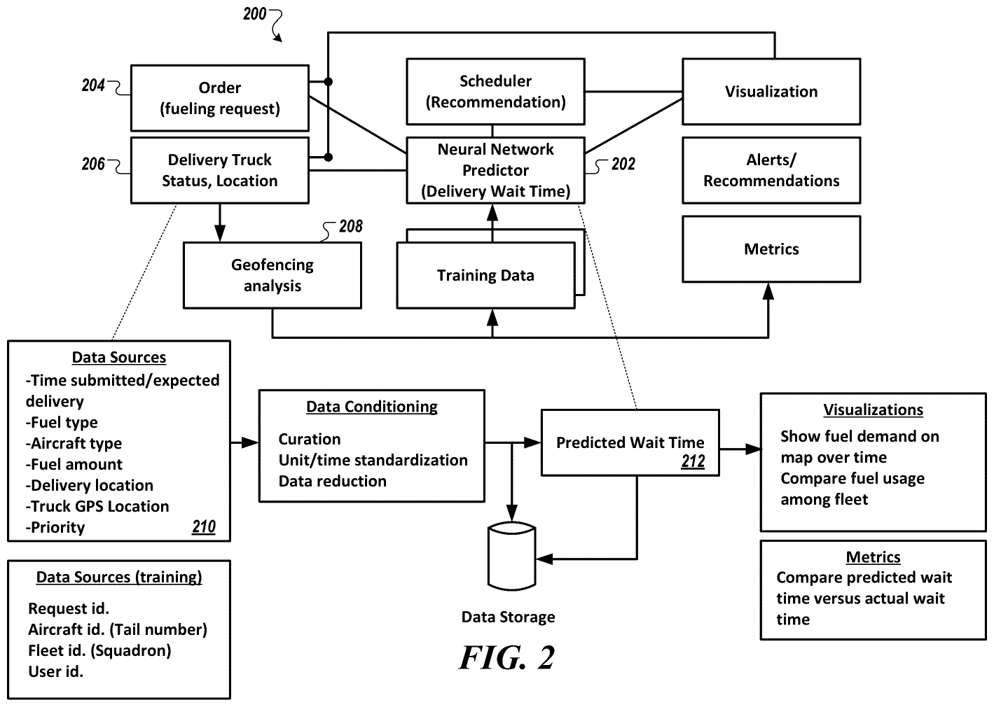

FIG. 2 shows an operational workflow 200 (e.g., of operation 101) of the logistical and predictive maintenance engine 102. In the example shown in FIG. 2, the wait time prediction module 104 (shown as “neural network predictor” 202) is configured to receive the fueling request order 204, e.g., via the ordering portal 114 and the delivery truck location and status data 206 from the 5G network and geofencing analysis 208. In some embodiments, the fueling request order 204 includes a request identifier, time of submission, fuel type, fuel amount, delivery location, truck GPS location, and priority request. In some embodiments, the time, fuel type, current truck location, delivery location, and priority (shown as 210) is provided as input to the trained neural network that then generates a predicted wait time 212. The data may be conditioned, e.g., for unit standardization or data format.

### Example Scheduler

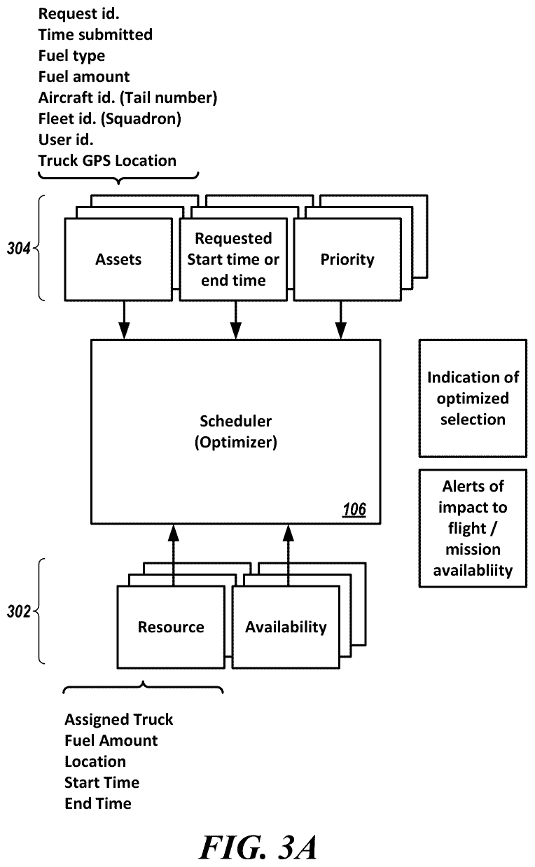

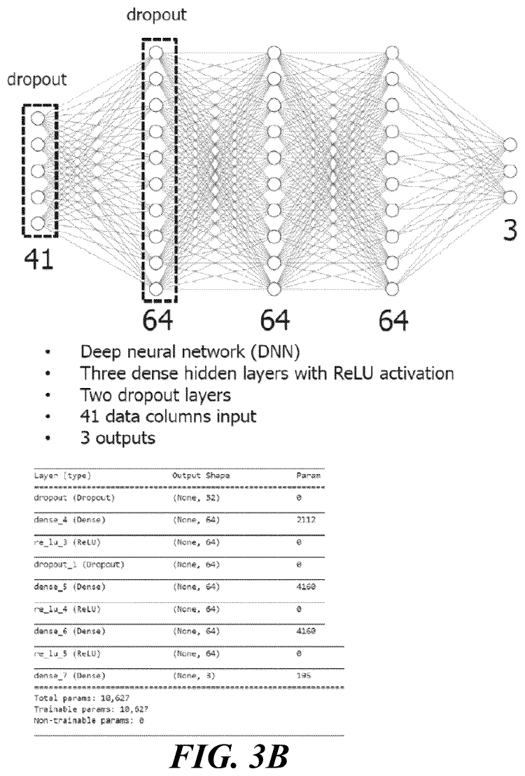

FIG. 3A shows a schedule (e.g., 106) configured to identify an available resource (e.g., fuel delivery slot or time) and associated available fuel delivery truck (and/or personnel). In the example shown in FIG. 3A, the schedular 106 (also referred to as a recommender) is configured to match the available resource 302 to a request 304. The available resource 302 may be defined as assignable trucks, current truck fuel amount, truck location, available start time, available end time. The request 304 may be defined as request identifier, time submitted, fuel type, fuel amount requested, aircraft identifier (e.g., tail number), fleet identifier (e.g., squadron id.), user identifier, and truck GPS location.

The optimizer can provide a recommendation via a solver, described below, that can be indicated to the user. The indication may indicate the trucks that if selected could impact flight or mission availability (thus having a negative recommendation). To this end, a positive recommendation could be the lack of presence of a negative indication.

Equation 1 shows an example optimization objective function for an objective function analysis, in a solver, that can be used for the scheduler 106. The optimizer can be configured to allocate Kᵢₙ tasks to Sᵢₙ delivery slots subject to delivery capacity constraints at stage n of aircraft i.

$$Minimize : {C}_{in} = f ( \text{?} ) \qquad ( Eq . 1 )$$

$$\begin{matrix}With respect to : & \text{?} \{ 0 , 1 \} n & ∀ k ∈ \{\end{matrix} 1 , ... , \text{?} \} \text{?} ∈ \{ 1 , ... , \text{?} \} \qquad ( 15 )$$

$$\begin{matrix}Subject to : & \text{?} Δ \text{?} \leq Δ \text{?} & ∀ s ∈\end{matrix} \{ 1 , ... , \text{?} \} \qquad ( 16 )$$

$$\begin{matrix}\text{?} Δ \text{?} \leq Δ \text{?} & ∀ s ∈ \{ 1 , ... , \text{?} \}\end{matrix} \qquad ( 17 )$$

$$\begin{matrix}\text{?} \leq 1 & ∀ k ∈\end{matrix} \{ 1 , ... , \text{?} \} \qquad ( 18 )$$

$$\text{?} \text{indicates text missing or illegible when filed}$$

[NOTE: will update equations 16-19]

The objective function is mathematically defined per Equation 19, where the quantity Sᵢₙ denotes the number of available fueling slots for airplane i at stage n along it's route. It is based on the total number of available slots Sᵢⱼₙ at airport j during stage n:

$$f ( \text{?} ) = \text{?} + \text{?} where {S}_{in} = ⌊ {β}_{in} \times \text{?} ⌋ \qquad ( 19 )$$

$$\text{?} \text{indicates text missing or illegible when filed}$$

The equations can be interpreted as: Eq. 16: time to complete the tasks assigned to each delivery slot cannot exceed maximum slot time; Eq. 17: time to complete the tasks assigned to each slot cannot exceed ground time; Eq. 18: the same task cannot be assigned to more than one slot (no repeats); Eq. 19: minimize unused resources and penalize any unassigned tasks.

The optimization scheduler can be similarly used for airport maintenance schedule optimization and other applications described herein.

### Example ML Wait Time Estimator

FIG. 3B shows an example neural network that can be configured as a wait time predictor module (e.g., 104). In the example shown in FIG. 3B, deep Neural Network (DNN) approach is shown configured for long periods of dropout having 3 hidden layers of size 64 with dropout included for possible regularization. It was observed that such configurations can yield good performance and low number of weights.

The ML algorithms can be configured to predict the overall wait time for fuel delivery, and can additionally, when desired, make inferences about what factors are related to longer wait time. For example, even though fuel delivery request information is collected only when fuel delivery is needed, other flight information is collected that can be useful. Included are the specific pilot and copilot, the airports, the temperatures at the site, and the type of aircraft, among other features. Since the delivery routes are known ahead of time, if the contribution of these features can be determined by solving the inverse problem then predictions become straightforward linear combinations of the known features.

More specifically, the ML algorithm can be configured to have a total of J features (i.e., wait time, pilot, temperature, pressure, etc.). Let xⱼ represent the jth feature such that the features the vector x is defined as [x₀ x₁ . . . x_{J-1}]^{T}, where x_{T} denotes the transpose of vector x. Each aircraft is equipped with M fuel. Over the course of information collection, the m^{th} fuel, is replaced Nₘ times, where m∈{0,1, . . . , M−1}. Each fuel delivery yields an equation in the mixing (i.e. linearly combining) matrix. Thus, the algorithm has a total of K=Σₘ₌₀^{M-1}Nₘ equations. Let [a_{k,0}, a_{k,1}, . . . , a_{k,J-1}] be the row vector formed by the set of coefficients for the kth equation multiplying the vector x. Then, the mixing matrix A is formed by stacking the K coefficient row vectors, k∈{0,1, . . . , K−1}. Since A is of dimension K×J, and x is of dimension J×1, the observation vector b is of dimension K×1 and the resulting equation is the standard inverse equation Ax=b. The estimated feature vector \hat{x}=Zb, where Z=ƒ(A) is a function of the mixing matrix A. There are several standard solutions to this inverse problem. The simplest and most common is to find the pseudoinverse matrix Zₚᵢₙᵥ=(A^{T} A)⁻¹ A^{T}. Once the feature vector is estimated, predictions can be made in a straightforward manner by forming the new mixing matrix Ã, based on the delivery plans and records, and forming the prediction vector \hat{b}=Ã \hat{x}.

Output from algorithms can then be stored and used to provide feedback to maintenance operator and decision makers as described in relation to FIG. 2. Visualizations can be used to give an overview of the aircraft and support infrastructure. Metrics are used to provide a check against the predictive algorithms against what actually occurred in the field. These outputs form the feedback mechanisms delivered to maintenance technicians, managers, and other decision makers, using both traditional visualizations and data pulls. In addition, other UI technologies such as HUD and AR/MR can be used.

The machine learning predictor can be similarly used for airport maintenance schedule optimization and other applications described herein.

Machine Learning. In addition to the machine learning features described above, the analysis system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an ANN is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

An Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Fuel Delivery Portal

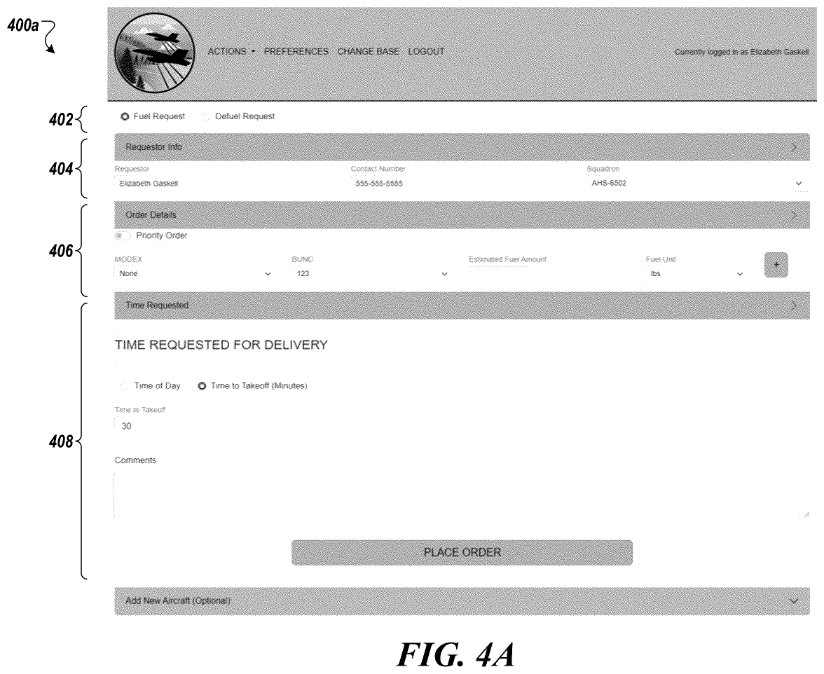

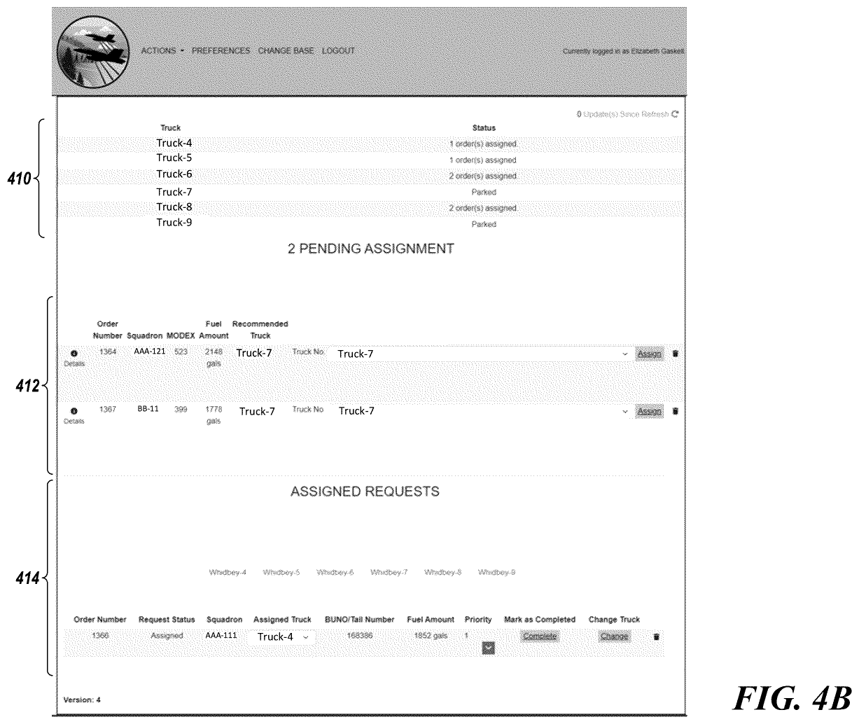

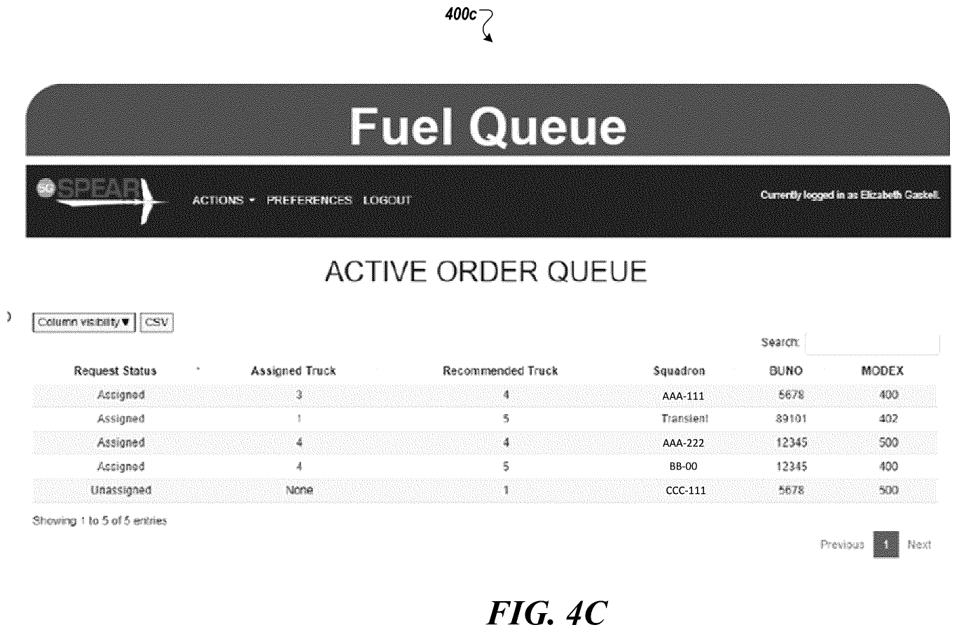

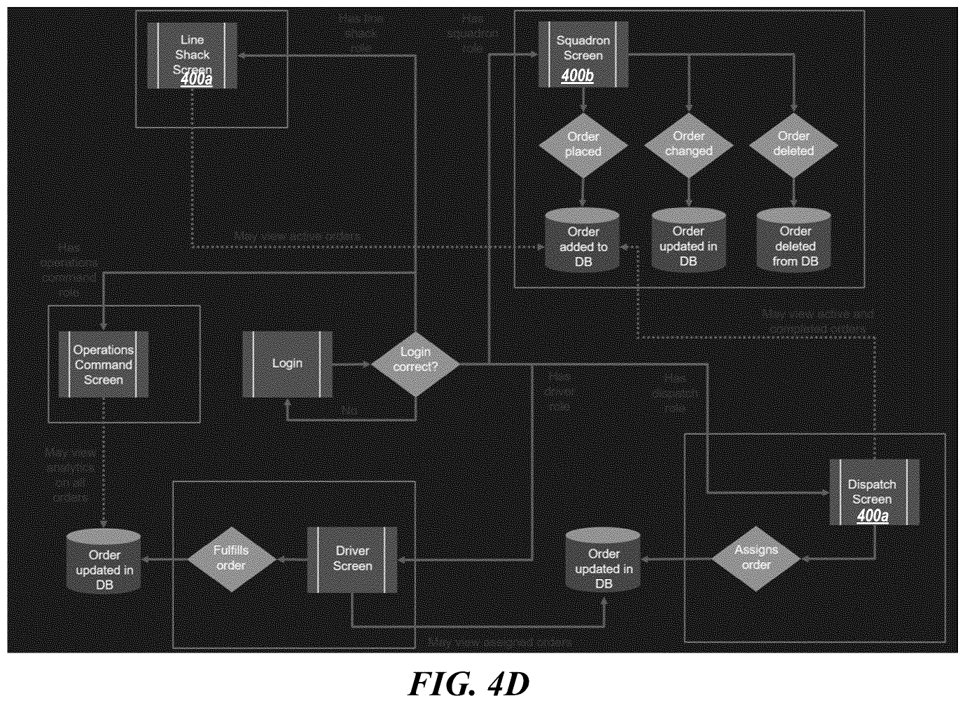

FIGS. 4A-4D show example visualizations for fuel delivery portal employing the predictive maintenance features described herein. In FIG. 4A, the fuel delivery order form 400a includes a request type 402 (e.g., fuel request or defuel request), the requester info 404 (e.g., name, contact information, squadron info), the order details 406 (e.g., modex value, fuel type, estimate fuel amount), and time for the delivery (e.g., time to take off or time of day).

FIG. 4B shows the subsequent fuel request order form with the fuel delivery information. In FIG. 4B, the form 400b displays the current fuel delivery assignment 410 by the asset, the new assignment based on the provided request 412, and the assigned request 414. The new assignment panel 412 allows a truck number to be selected and assigned. The assigned request panel 414 allows assignment of trucks to be modified (e.g., reassignment, marked as completed).

FIG. 4C shows an example status order queue 400c.

FIG. 4D shows an example sequence of the portal for screens 400a, 400b, and 400c.

### Experimental Results and Additional Examples

Research and development programs were undertaken to develop, refine, and implement a data pipeline architecture (also referred to as “SPEAR”) for a predictive maintenance system. While the underlying framework and challenges affect a wide range of needs, Predictive Maintenance (PMx) and the operational impact to logistical scheduling and implementation of PMx actions on the flight line were at the core of the programs. One program focused on optimizing predictive maintenance for military aircrafts and assets, including predicting wear and maintenance on aviation tires and optimizing predictive maintenance scheduling for them. Another program, to provide refueling, took the output of the first program and extended the framework to aircraft refueling operations.

In the first program, and eventually with the second, the strategy was to build out the component parts of a predictive maintenance system using: data pulled from public sources, artificially generated datasets generated by the operations team leveraging their knowledge of what is currently captured in the field, or data from sponsors. This data undergone rounds of data conditioning to unify the data sources into a single architecture and to prepare the data for automated analysis. This data were streamed in, pulled in through automated jobs, or imported in ad-hoc pushes. Once conditioned, analytic algorithms ran on the data, most likely in batch processing due to the nature of aviation tire data. Ad-hoc analyses were also performed.

The R&D program began with ReMAP's scheduling optimization DSS [2] in which working code and user guide from the author of [2] were acquired and the DSS's logic and flowcharts were translated into Operational View (OV) diagrams to form the basis of the MBSE research. The R&D then developed scheduling optimization of the DSS, adjusting its ruleset to account for stakeholder priorities and to allow for insertion of PMx activities.

The R&D program (task 1) developed a fully functional end-to-end data pipeline demonstrating proof-of-concept rapid response capability for aircraft tire wear using computer vision. The R&D program (task 2) increased the pipeline's fidelity and robustness (handle additional use cases/data streams plus logistical/ops planning algorithms) and inserted a mixed/augmented reality user capability. The R&D program (task 3) then deepen the core modeling functionality using a quasi-physical AI approach leveraging existing H-60 Computational Fluid Dynamics (CFD) and Computational Structural Dynamics (CSD) models, data for AI/Machine Learning (ML) training/verification and validation (V&V), and Heads Up Display (HUD) interface capability.

The R&D program (in task 1) demonstrated a pipeline that provides a remaining useful life estimation for aviation tires based on available O&M data and interviews with maintainers. This estimation generated visualizations that can be used by maintainers on the flight line, demand forecasting for back-office inventory managers, and high level view for fleet comparisons. Streaming data was incorporated from live sensors in the form of weather data, and are using that streaming data to drive a Hololens visualization that can be used for demonstration. The self-contained data pipeline was developed within the GTRI infrastructure, allowing for experimentation while controlling costs, as well as permitting us to run independently of a cloud service.

In task 2, the R&D program built up the complexity of the data pipeline framework, including optimizer functionality and basic flight regime characterization. The R&D program continued analysis of aircraft tire-based challenges and increased its engagement with other PIs/organizations.

The R&D program (in task 4) developed a predictive pipeline that provides estimated and optimized delivery time for aircraft fuel.

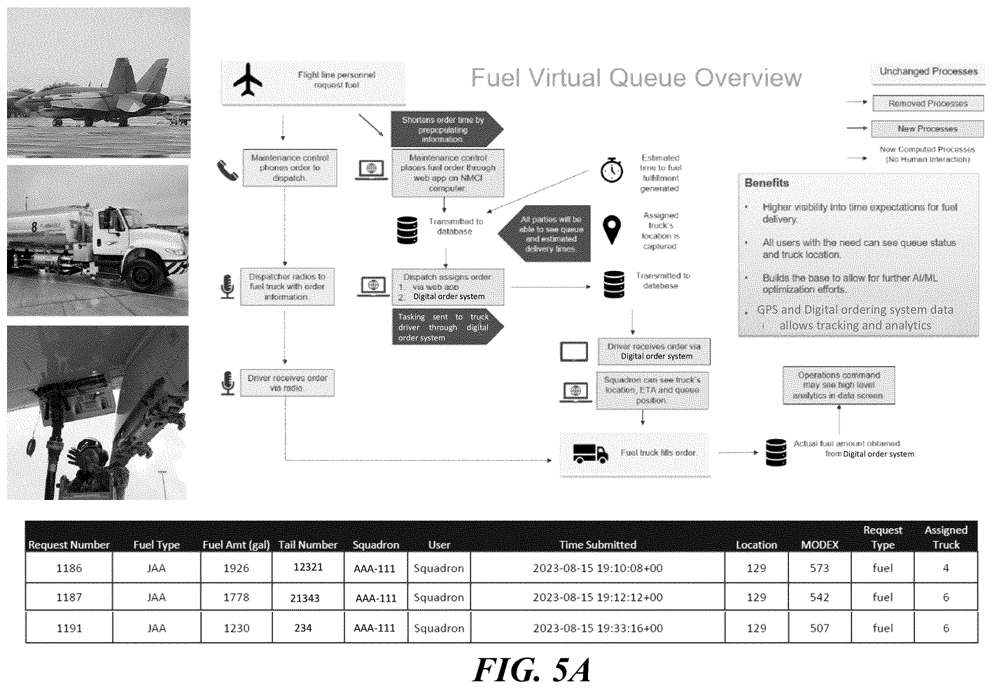

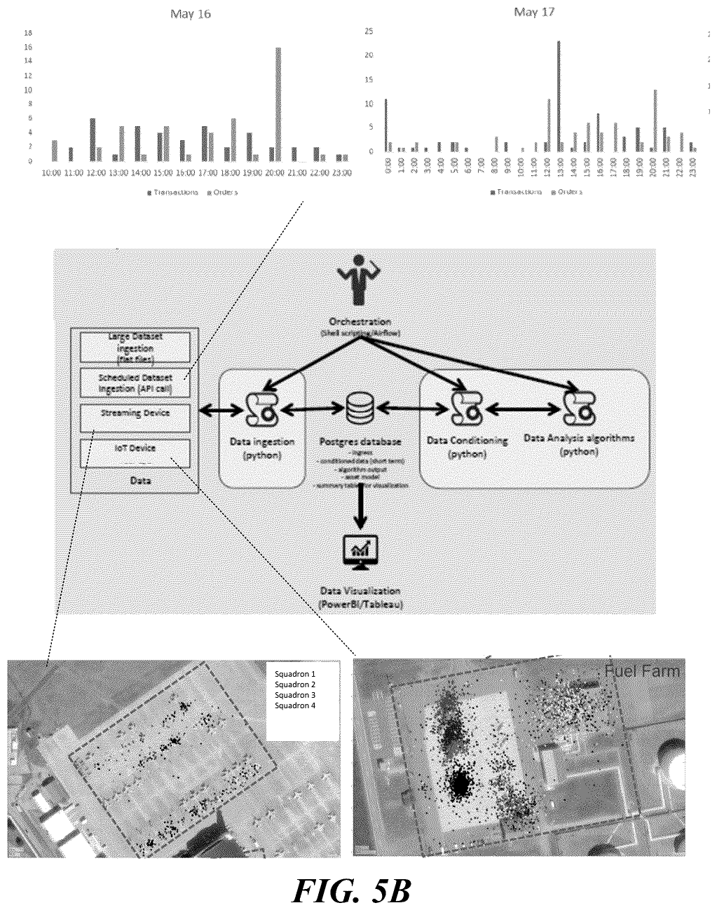

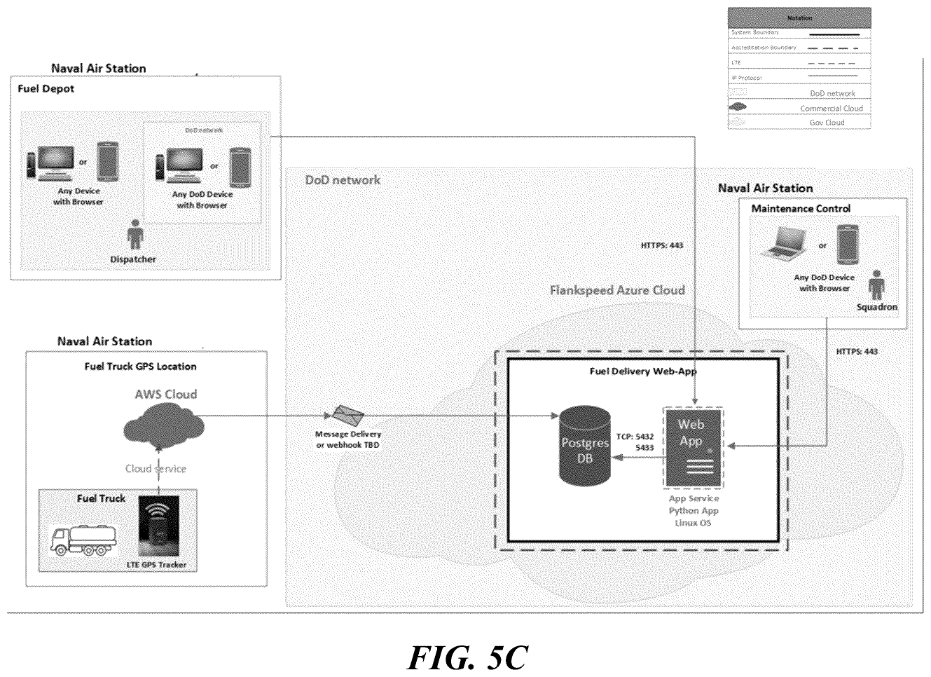

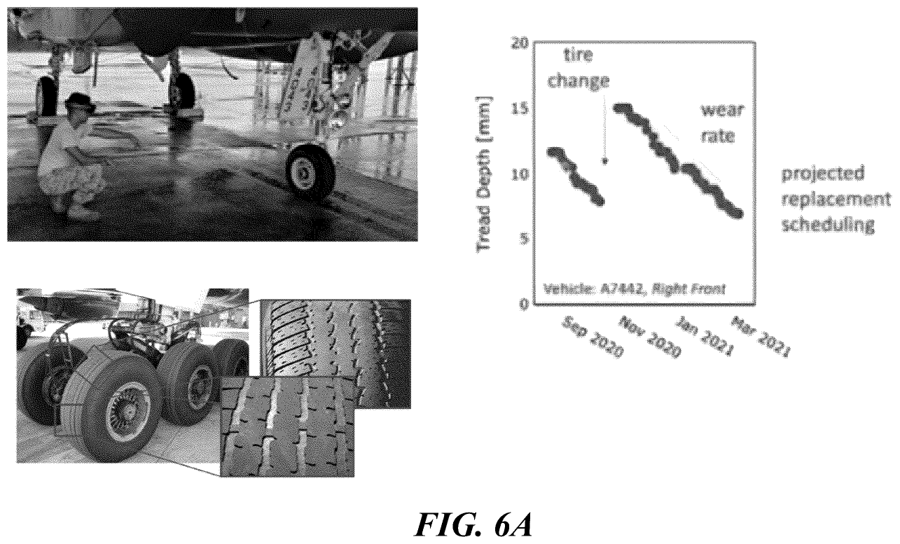

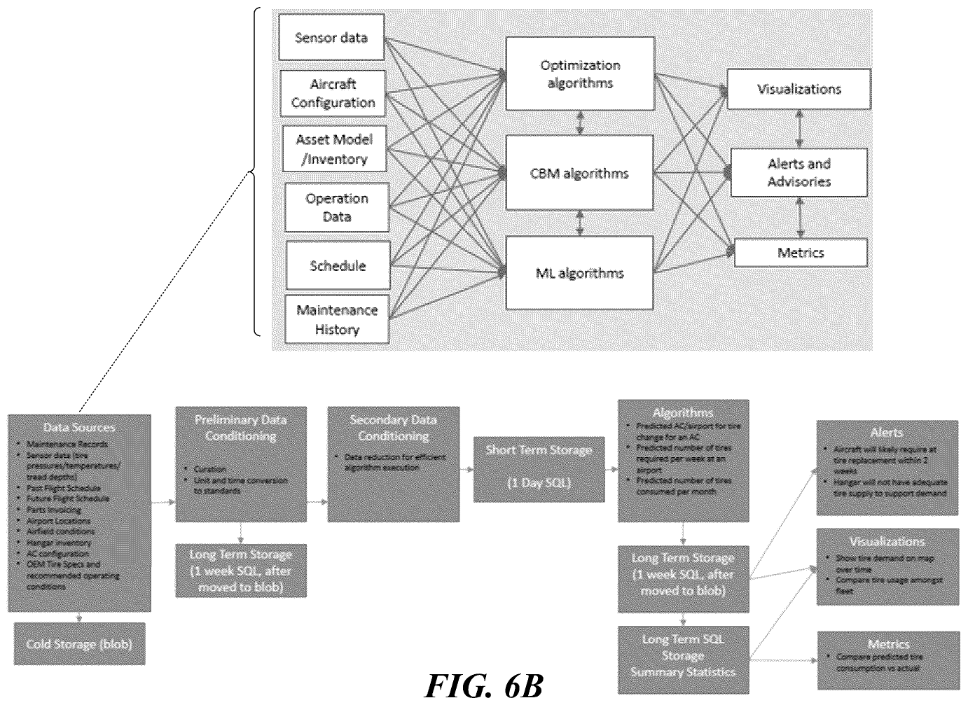

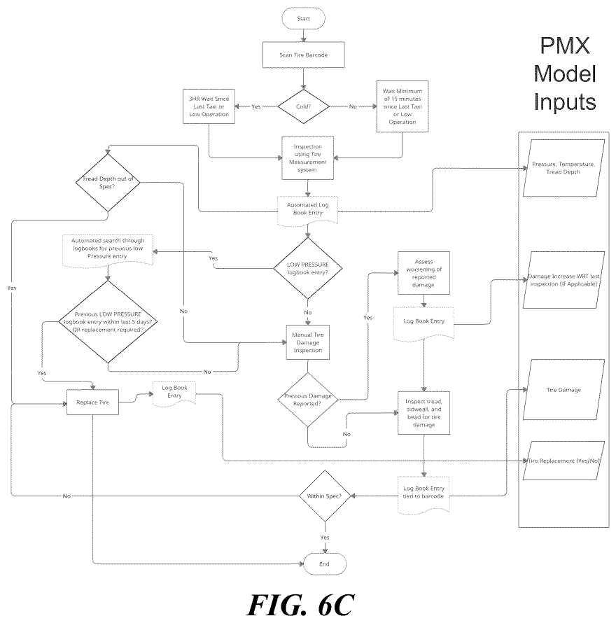

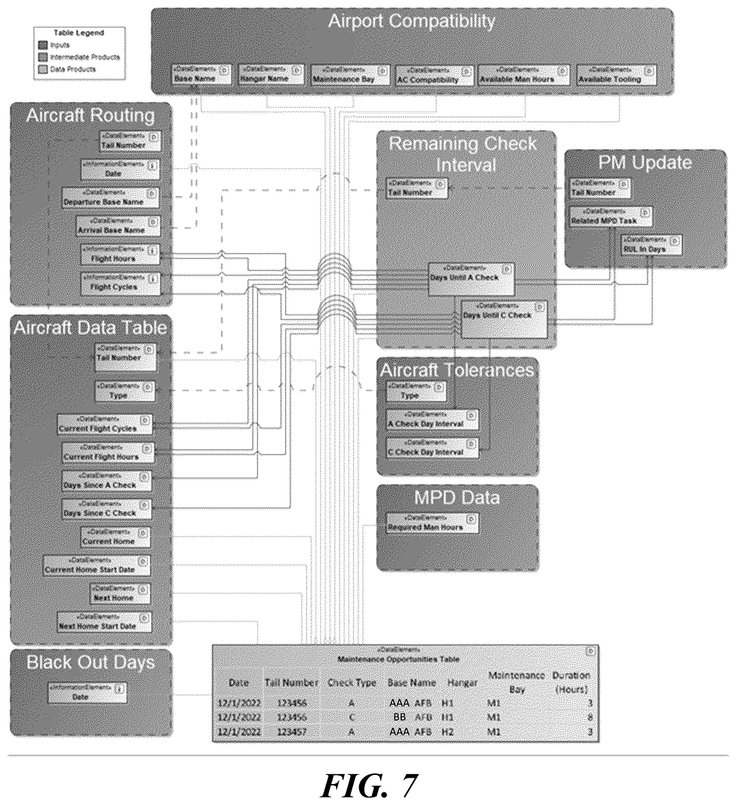

FIGS. 7 shows a PostGres Table for a ReMAP's DSS for Aircraft Maintenance Planning Optimization (AMPO). FIGS. 6A-6C show program details on the tire wear predictive maintenance operation. FIGS. 5A-5C show program details on an aircraft refueling truck logistical operation that is based on predictive maintenance models.

### Predictive Maintenance for Aircraft Tire Replacement

For task 1, the R&D program developed a ML algorithm that can predict for predictive maintenance when aircraft tires need to be replaced in advance, allowing maintenance and logistics teams to have spare tires on hand, optimize storage and routing, and prevent catastrophic failure. The ML model initially relied on information that is already collected by maintainers, including the binary decision for each tire at each landing location, i.e., every time the aircraft lands a visual inspection is performed by a human and a decision is made as to whether each tire on the aircraft needs to be replaced or not. For example, if “needs replacing” is denoted by a 1, and “doesn't need replacing” is denoted by a zero, then a replacement on the 7^{th} landing would be denoted by the sequence [0 0 0 0 0 0 1 0 0 . . . ].

While no new information is gathered at each time point unless a replacement is determined as needed presents a unique challenge for the ML algorithm, the ML algorithm collected information at each time step and used the new information to improve predictions. Indeed, information from multiple features over multiple time steps were combined for each iteration of the inference algorithm. FIG. 6A shows an example of data acquired for the machine learning, including the wear rate and the point in which tire is changed.

The R&D program developed a data pipeline module comprising architecture, operations & logistics, data acquisition, algorithms, and user interaction. FIG. 6B shows the architecture of the data pipeline module. In FIG. 6B, the ML algorithm is shown operable with CMB algorithms and optimization algorithms to provide visualization and alerts/advisories. The ML algorithm, optimization and CMB algorithms would employ maintenance records, sensor data (e.g., tire pressure, temperature, thread depths), past and planned flight schedules, parts invoices, environment conditions such as airport locations and airfield conditions, hangar inventory, and manufacturer's specification (e.g., recommended operating conditions). The algorithms could provide an output estimation or prediction on when a tire change is required, a predicted number of tires required per week or month for a given site/airport.

The architecture was based on a Kubernetes-based edge device (e.g., reusable microcloud) to support model development and experimentation. A rack processing system was built out and used as a staging system for multiple projects and as a box for Kubernetes/Dockerizing applications. A second rack unit was designed for more ruggedized applications. The R&D program developed utilizing internal resources including Ice Hammer and Atlassian.

The R&D program identified business logic necessary to optimally schedule routine aircraft maintenance while building software to perform scheduling optimization and identified maintenance operational decision-making, and end user interfacing requirement. The R&D program also identify how component wear and replacement is managed and recorded and document maintainer process flow for components. The software was developed using React, Postgres & Python to optimize schedule via forward induction. Analysis of tire replacement data was performed across major airframes. The R&D program explored the primary maintenance information system (GO81) ability to tie job codes on predictive maintenance alerts.

Tire failure was predicted by tracking the number of landings that occurred upon failure of each tire type. A Weibull analysis was conducted to determine the mean number of landings to failure for each individual tire. A two-sample t-test for unequal variances showed a significant difference between the number of landings to failure for Main Landing Gear(MLG) and Nose Landing Gear(NLG) tires(MLG mean: 44.673, NLGmean:3 9.739, p=0.0003). NLG failures happen with fewer landings than MLG and NLG tires require more frequent orders.

For Data Acquisition/Conditioning/Algorithm development, the R&D program quantified challenges surrounding maintenance coding with Work Unit Codes(WUC) including conducting a Weibull analysis, integrated into a dashboard for predicting tire maintenance. The R&D program acquired and used in-flight measurements captured during a scripted flight to identify anomalous behavior for intelligently summarizing wear on an aircraft. The R&D program developed workflow for automated data conditioning utilizing historic data. FIG. 6C shows a developed workflow for data collection of measured information to be used for the predictive maintenance, including pressure, temperature, and thread depth information, assessed damage/change in thread depth from last inspection, presence of tire damage, and if request for tire replacement was requested.

In algorithm development, the R&D program evaluated anomaly detection, root cause analysis, remaining useful life, maintenance optimization, demand forecasting. The R&D program identified PMx modeling algorithms utilizing flight data recorder data. The R&D program ported and integrated aviation scheduling optimization system initially developed at TU Delft and used by KLM. The R&D program developed demand forecast views for supply chain. The R&D program captured rotorcraft flight data measurements using a scripted flight. Principal component analysis identified anomalies in flight to be used for intelligently summarizing the wear on an aircraft.

The R&D program also developed object detection pipeline, for the interface aspects, that allowed users to program new features to be detected on a UI platform of choice (demonstrated using the Holo Lens 2). The R&D program developed multiple user interfaces (e.g., maintainer, hangar manager, executive, and supply chain levels). The R&D program developed dashboard data visualizations in both PowerBI and Tableau targeting metrics for maintainers, executive level, and hangar managers. As shown in FIG. 6B, the alerts can be based on when the aircraft would likely require tire replacements in the next 2 weeks and if a hangar would not have adequate supply for replacements.

Discussion. For aviation applications, tires requiring servicing, repair or replacement are a leading operational interruption driver, requiring a maintenance action in response to a problem. It is possible to save significant operation cost with proper tire RUL predictions. Failure to adequately recognize when wear has reached specific thresholds causes damage to the tire's underlying structure, preventing retreading and driving supply chain costs and availability challenges. As a result, most operational maintenance organizations include regular (i.e., daily) tire inspections on every aircraft in their inventory. Tire tread depth generally requires measurement with a specialized tire gauge and visual monitoring of flat spots, skids, or tread rib damage. While a relatively straightforward maintenance task, the addition of predictive maintenance analytic support could significantly cut the amount of time spent on this task while also automating data collection.

### ReMAP's DSS for Aircraft Maintenance Planning Optimization (AMPO)

As an initial part of task 1, the R&D program adapted REMAP's scheduling optimization at KLM Airlines to a CBM+ maintenance strategy for the KC-46A, developing models to determine what activities and data are needed to incorporate PMx actions into the Deng et al. [2] optimization techniques. The R&D program analyzed and modified several functions comprising AMPO-1/2's scheduling process to optimally schedule PMx actions based on operational and resource constraints. The R&D program developed scheduling optimization model and various operational activities in the scheduling optimization model. The R&D program moved towards a more fully realized CBM+ environment with new sensors that allowed for the real-time reporting of component conditions.

PMx Data Pipeline. A PMx data pipeline was developed, as another example of predictive maintenance, that could connect component-level PMx models and techniques to the entire aircraft system. Models were developed through techniques, including experimental correlations, anomaly detection, flight regime recognition, physics-based modeling (i.e., CFD and structural modeling), and AI/ML (e.g., digital twin and virtual sensors), and a combination of both using physics-based ML to provide forecasting to predict remaining useful life (RUL). The work built upon previously completed sponsored work developing virtual sensors for the HH-60 4G accelerometer using both historical data and synthetic signal development through CFD.

For the AI model development, corrupted data were characterized via statistics, including logic to flag data as either corrupted or intact. The development determined the nature of the corruption (e.g., did the sensor fail altogether or is it simply reporting values that are physically impossible?), calculating the relative proportion of flight records that contained various levels of corruption (e.g. <1%, 1-5%, 5-10%, >10%), determining the length of burst-corruption and the relative proportion with which each length occurs (e.g. single corrupted samples, corruption bursts <10 samples, 10-100 samples, 100-1000 samples, >1000 samples, etc.). After characterizing the statistical nature, the data was tailored to the specific properties of the AI model so that the model may both 1) learn from and leverage correlations and trends, and 2) remain robust to the anomalies present in the data. The AI model was refined through a thorough error analysis. For categorical models, this entailed inspecting the training examples that the model incorrectly classified; for regression models, ranges of error are defined to delineate which examples perform well and which perform poorly. Error analysis can elucidate anomalies that may be contributing either negatively or positively to performance, and, depending on the prevalence of the anomalies and their performance relative to the larger population, priority in addressing their effect can be assigned. Thorough error analysis can also help identify trends in performance that can be leveraged to improve the model.

The R&D program also designed and generated CFD simulations to create synthetic data for a stacked model approach. The simulations, aerodynamic loads were generated for an HH-60G during certain specified flight maneuvers. A method of signal replication of a virtual sensor was developed with the ability to differentiate between vehicle internal forces due to the motion from aerodynamic loading forces. This was done using a CFD simulation model in CREATE-AV Helios.

The combination of CFD and AI model development provided a framework for developing triggers for a sub-system. Physics-based ML has also been used to develop aerospace-related approximate models for high-dimensional physical systems, such as predicting flow over an airfoil using proper orthogonal decomposition (POD) model coefficients. Other models have been used to predict the performance of mechanical sub-systems, such as rolling bearings, in order to predict non-linear behavior of failure modes and expand the predictive maintenance capabilities. This proposed work will expand upon the group's previous work and previous examples to include additional triggers and investigate the methods to combine triggers, determine when triggers are false, and how to insert alerts into the rest of the system.

The data pipeline also incorporated active learning such that continuous data collection can improve upon the operating picture, increase the accuracy of an existing model, or develop new models.

Deng et al. [2] built a stand-alone software prototype for AMPO using the programming language Python. The DSS of [2] included three component layers, a database, a model, and a graphical user interface (GUI). The R&D focused on the model layer which included three optimization models: a maintenance check scheduling model, a maintenance task allocation model, and a shift planning model. The optimization via the MPO tool could autonomously process and subsequently insert an associated task onto an existing check, ensuring that the component is fixed before it expires, but without the need to create a new hangar visit.

The DSS first generates an optimal aircraft maintenance check schedule then allocated the maintenance tasks to each maintenance check. After that, it planned the shifts according to the maintenance tasks.

The Maintenance Planning Optimization (MPO) process was the R&D was considered in several stages. The first input stage evaluated operational data from the fleet, such as crew or Aircraft Communication Addressing and Reporting System (ACARS) reports that drive PMx events due to various issues noticed during operation. Because PMx events could also be driven by reports coming from maintenance personnel, maintenance findings were also evaluated to identify needs to change a component within the near future.

The analysis employed other inputs that come from the fleet are aircraft usage and operational constraints, e.g., to determine how soon the aircraft will need a check, based upon intervals set by the original equipment manufacturer (OEM) in the Maintenance Planning Document (MPD), and the Scheduled Inspection Technical Order (TO-6) document. The analysis also employed operational constraints that included aircraft schedules and routing data to allow the algorithm to determine when the various aircraft in the fleet will have an opportunity for maintenance, based on regularly planned flight schedules. The analysis evaluated the role of personnels in the optimization loop to ensure that maintenance requirements are continuing to be met as the schedules are adjusted. The R&D focused on scheduling optimization.

Schedule Optimization. The R&D modified the Deng et al. [2] DSS to handle PMx updates in addition to the KC-46A's regularly scheduled A and C check inspections. The R&D modified the ReMAP logic to allow for the insertion of PMx activities; rebuilt the Delft code based on the logic set down by the model to incorporate the above changes and allow for inputs from USAF data repositories; constructed a tool (“Data Analyst” tool) to work either as part of, or in parallel with, the MPO Tool that would be capable of producing PMx updates based on real data, inserting it into the MPO Tool at the appropriate step of the process, and executing the MPO Tool's schedule optimization functions as necessary. The “Data Analyst” tool sent PMx updates to the MPO Tool, causing it to run its normal schedule optimization algorithm while considering the new PMx variables.

The Analyst/MPO Tool facilitated the optimal scheduling of aircraft checks and inserted PMx activities into those checks where possible, in order to repair components before they fail without the need to create any new maintenance visits that are outside of the regular maintenance routine. Sending activities straight to the Line or Hangar creates additional workloads and logistical strains due to its irregular nature, and therefore was considered as a last resort.

Results. The optimization algorithm began by ingesting the MPD and equivalent military documents (such as the TO-6), as well as the status of the fleet. The MPD allowed for the extraction of check task intervals, while military documents give the maintenance check intervals themselves. The fleet status gave the average daily utilization of each aircraft, as well as the current aircraft flight times. Once the data were pulled in, the algorithm calculated the time until each check and task are due. The calculations were based on current aircraft usage (flight times) as well as calendar days. For simplicity, flight times were converted to remaining days based on the projected routing and utilization of the aircraft. Therefore, whichever remaining day interval was determined to be shorter is kept to be used later when deciding upon the check and task deadlines.

The algorithm then inserted PMx activities where appropriate. The Data Analyst tool included a decision logic tree that could take in PMx updates in the form of a component's Remaining Useful Life (RUL) (also referred to as Task and Remaining Interval (TRI)). The TRI designation allowed the relation of the component in question to be drawn to the actual maintenance task for that component.

When creating a check schedule with the MPO Tool, the Analyst added the insert to the list of tasks in the schedule. The MPO Tool would shorten the remaining check interval to ensure that the check was scheduled before the new RUL/TRI expired. However, if a check schedule already existed, then the Analyst would try to insert the task into a current check that is as close to the new deadline as possible. If it cannot get one near the new deadline, it would attempt to schedule it early. If this failed, then it would try to create an event for Line Maintenance. If the maintenance action could not be completed in a line environment, and the task was not considered high risk, then the task would be placed on a later check after the new TRI expired. When the task cannot be fit onto a check before the new TRI expired, and it is considered high risk, the Analyst would create a new, separate hangar visit outside the regular check schedule.

When inserting PMx tasks onto checks, the MPO Tool calle the TRI and Remaining Check Interval (RCI) that were generated in the previous step and replaces these with the new intervals generated by the Analyst and PMx Update. RCI was used to insert a task onto a current check schedule and only considered if a new check schedule is going to be generated. After the checks have been scheduled, TRI would be considered by the MPO Tool.

The next step involved having the user identify the planning horizon for the MPO Tool. The tool would identify maintenance opportunities within the planning horizon, and therefore only schedule checks and tasks within this horizon. The step was inserted before opportunities are identified, rather than after, so the tool does not waste processing power trying to identify opportunities that would not be used, which also helps to simplify the check scheduling process.

To identify maintenance opportunities to optimize, the algorithm first iterated through every aircraft, picked a check type for that aircraft, and grabbed its check intervals. It also identified airports where the aircraft would be routed within the planning horizon and iterated through the airports. As aircraft often operated and received all of their maintenance at a single base, the tool was configured to allow for multiple sites/bases as an efficient option in emergency or wartime scenarios. The algorithm was provided a “Home Base Only” selection that the user can toggle as desired.

When the aircraft is going to be at a base on a specific date, the algorithm checked the base, every hangar, and every maintenance bay, to confirm sufficient workforce and tooling to perform every task of the chosen check type on that aircraft on the day that it will be at the base. If all these levels of iteration return true, then this date was counted as a maintenance opportunity. In this case, a maintenance opportunity was a set of data that included the date, base name, hangar name, maintenance bay, check type, and check duration. After determining the date to be a maintenance opportunity, the algorithm checked for other maintenance opportunities every day, hangar, airport, aircraft, and check type corresponding to that aircraft and its routing schedule has been checked.

The next step involved generating the check schedule. The algorithm used a triple-series optimization function that checked every aircraft, checked types for that aircraft, and days within the set of feasible actions (maintenance opportunities). For every possible combination, it weighed the objective value of these combinations by considering the total unused flight hours of the fleet (due to being grounded for maintenance), as well as certain penalty functions like having to ground an aircraft in the case that it overruns its interval and has to wait on a check.

When the algorithm finds the combination that has the minimum objective value (fewest unused flight hours and associated grounding penalties), it used this combination to produce the fleet's check schedule.

The next step involved generating the optimal task allocations for each scheduled aircraft check. The MPO tool as a whole was designed so that the user can either run the entire process to generate a full check and task schedule for a fleet, or to begin with an existing check schedule and re-arrange the tasks that are in it. This allowed a user to insert PMx activities into checks without having to change the check schedule itself and create new maintenance events, which was to generate stabile schedules in a CBM+ environment.

To accommodate the PMx activities, models modified the process to calculate the due date of each incoming task using the previously determined TRI. At this point, it also looked at the workloads for this task in cases where the part in question needs to be accessed and in those where it has already been accessed (therefore the workload is shorter). There was also an opportunity for the operator to include custom workloads based on experience rather than the estimated workloads coming from the OEM.

If the part is to be accessed in a standard MPD task, that task has a similar deadline, and there is room for the PMx task on the check, then the tool would attach the PMx task (with the lower workload that does not include access/close tasks) to a related check task defined by the MPD. If it was unable to do this (e.g., there is no related MPD task), it would create a new task with the full workload and place the task into the list of tasks that need scheduling.

The final step involved shift planning model in which tasks were allocated to maintenance shifts, starting with panel access tasks and ending with closing tasks. The tool continued iteration through shifts and days until all tasks have been allocated to a shift. When it finished, the DSS had completed its processing and stored the results in its database according to the aircraft tail number of the tasks. The final result included the aircraft maintenance check schedule (i.e., which aircraft will be in the hangar/depots at which airport/base on which day), the list of tasks to be accomplished in each of those checks, and the shifts in which those tasks are to be executed. This is referred to collectively as the Maintenance Execution Plan (MEP).

PostgreSQL tables. FIG. 7 illustrates how the critical elements of the first half of the algorithm, Maintenance Opportunity, is formed. As described previously, it references Aircraft Routing data in combination with Airport Available to determine a potential maintenance visit. If this visit can occur between the RCI (which is itself determined by using the Aircraft Data Table and regular check tolerances), and does not conflict with a Black Out Day, then the visit becomes a Maintenance Opportunity.

Constructing the model to this DIV-3 level allowed for direct translation into PostgreSQL tables. In FIG. 7, Blue tables are representative of Input tables, which will be the source tables in the database. These tables were loaded with proxy data to allow the programmers to construct and run tests of the algorithm. The blue-green table, RCI, is colored so as to mark it as a product table. No starting data is to be put in this table, but rather it is solved for through the algorithm. The Maintenance Opportunity Table is solved in the same way, but is colored yellow to show that it is the ultimate goal of this specific DIV-3. Naturally, DIV-3s were also constructed for the other steps of the AMPO 1, 2, and 3 processes. By following this workflow, the modeling output was able to provided for the programing with a common database.

By constructing the models, software programmers can be informed of how to modify the MPO Tool. The model was originally constructed to visualize each step of the process and place it in the maintenance context. The visualization of data flows within the MPO tool allowed for the identification of the ideal place for PMx inserts, and to develop how these should be processed at a conceptual level and ensure that these concepts could be translated to the programming team.

Therefore, as the OV-5b for the MPO tool was developed, it was ensured that the model was translatable into code. This enhanced our ability to identify holes that would be created by our desire to insert PMx activities, from the more conceptual issues this raises such as logistical and supply strains, to more programmatic issues such as how to determine what specific measurements and variables should be considered by the tool in order to determine what is a maintenance opportunity and what data properties should accompany such an element.

After refining these OV-5b diagrams to a satisfactory state, data tables were designed for incorporation into a PostgreSQL database that would be constructed for the MPO Tool. Therefore, we turned our attention to modeling the data that would be needed by the algorithm. A simplified Physical Data Model (DIV-3) can be seen in z,999 7, which shows the database tables and relationships that are used in the first half of the MPO tool's process steps.

### Predictive Maintenance for Aircraft Refueling

For task 4, the R&D program developed an ML algorithm that can predict for predictive refueling conditions for aircraft using analytic for operations/logistics application.

FIG. 5A shows a diagram of a fuel dispatching workflow that is modified with to incorporate the predictive refueling operation. FIG. 5A also shows an example fuel order request.

Training. FIG. 5B shows an example training data set collected for a given site/airport that shows the number of orders and transactions. The training data set can be used to train, e.g., a deep neural network, e.g., described in relation to FIG. 3B. In FIG. 5B, the ML algorithm is shown operating in concert with a data ingestion module that can ingest large data set, scheduled data set via API calls, as well as data from streaming and IoT device. In this example the IoT devices includes geofenced information of truck GPS locations. FIG. 5C shows cloud analysis configuration for the data collection.

### Discussion

Aircraft maintenance operations continually increase in complexity as operators expand their fleets with more advanced aircraft. In response, commercial industry has made great strides towards optimizing their maintenance environment, as profit margins are decreased by maintenance costs. In a commercial operation, money is lost when an aircraft is grounded, and thus ground time is sought to be minimized.

Europe's real-time condition-based maintenance for adaptive aircraft maintenance planning (ReMAP) program proved successful in optimizing maintenance schedules at KLM Airlines [1]. ReMAP's optimization decision support system (DSS) was primarily built by Technical University (TU) Delft, Netherlands [2].

In contrast, military aviation is not profit-driven, and maintenance operations are motivated by the need to maintain aircraft readiness to support missions. The decline in readiness observed by the U.S. Government Accountability Office [3] coupled with a substantial $78B annual maintenance budget in the Department of Defense (DoD) [4] is driving military aviation to optimize their approach as well. To address this, USAF subject matter experts [5] and policymakers [6] positively highlight commercial derivative aircraft programs, such as the KC-46A Pegasus, that leverage commercial resources and advancements to improve lifecycle performance and costs. Additional sustainment improvements directed by the DoD include usage of condition-based maintenance plus (CBM+) approaches [7] intended to realize the benefits of Predictive Maintenance (PMx) capabilities [8].

Utilizing ReMAP's DSS, the exemplary system and method employ commercial scheduling optimization to the USAF KC-46A fleet by advancing the original optimization model Deng et al. developed [2] to include KC 46A CBM+ PMx alerts. These PMx actions are incorporated into optimized preventative maintenance schedules (i.e., letter check scheduled inspections) while subordinating to operational and resource constraints. The enhanced scheduling optimization model demonstrates how the USAF can increase the operational availability of KC 46A aircraft and reduce costs through optimally scheduling PMx actions across an integrated long, mid, and near-term schedule.

It must also be noted that, as used in the specification and the appended claims, the singular forms “a,” “an,” and “the” include plural referents unless the context clearly dictates otherwise. Ranges may be expressed herein as from “about” or “ 5 approximately” one particular value and/or to “about” or “approximately” another particular value. When such a range is expressed, other exemplary embodiments include one particular value and/or the other particular value.

By “comprising” or “containing” or “including,” is meant that at least the name compound, element, particle, or method step is present in the composition or article or method but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The following patents, applications and publications as listed below and throughout this document are hereby incorporated by reference in their entirety herein.

[1] Windemeijer, Christine, “ReMAP results—get to know what we've achieved!,” H2020 ReMAP Available: https://h2020-remap.eu/remap-results-get-to-know-what-weve-achieved/
[2] Deng, Q., Santos, B. F., and Verhagen, W. J. C., “A Novel Decision Support System for Optimizing Aircraft Maintenance Check Schedule and Task Allocation,” Science Direct, Available: https://doi.org/10.1016/j.dss.2021.113545

### [3] Joint Artificial Intelligence Center, “Mission Ready: How the Joint Logistics MI Supports Warfighters.” 2020.

### [4] Weapon System Sustainment, “Selected Air Force and Navy Aircraft Generally Have Not Met Availability Goals, and DOD and Navy Guidance Need to Be Clarified.” 2018.

### [5] M. S. Low, “Impact of Decision Criteria on Federal Aviation Administration Certification of Military Commercial Derivative Aircraft.” 2012. In.

### [6] USAF, “Air Force Instruction (AFI) 62-601: USAF Airworthiness.” 2010.

[7] Group, C.A. Condition Based Maintenance Plus (CBM+) DoD Guidebook, Office of the Secretary of Defense. May 2008.
[8] J. Levitt, Complete Guide to Preventative and Predictive Maintenance, 2nd ed. New York, NY: Industrial Press Inc, 2011.

What is claimed is:

1. A system comprising:
a predictive maintenance engine having instructions to execute:
a dataset ingestion module configured to receive and to format data from a database, including an aircraft fuel order for a fuel delivery;
a trained neural network configured to determine a predicted wait time for a set of aircraft fuel trucks based on the aircraft fuel order; and
an order interface configured to display the predicted wait time for each of the set of aircraft fuel trucks.

2. The system of claim 1 further comprising:
a geofencing analysis module configured to determine start fueling time and stop fueling time for a given fuel delivery order, wherein the start fueling time and stop fueling time are used to update, via a re-training operation, weights of the trained neural network.

3. The system of claim 1, wherein the aircraft fuel order includes order information comprising an order time submitted, a requested fuel type, a requested fuel quantity, an aircraft identifier, and a truck GPS location, wherein the order information are provided to an input layer of the trained neural network.

4. The system of claim 1, wherein the trained neural network was trained via a training data set comprising a set of transaction, each transaction comprising: order time information, requested fuel type, requested fuel quantity, aircraft identifier, and truck GPS location.

5. The system of claim 1 further comprising:
a scheduler configured to match, via a solver, an available fuel delivery truck to a set of aircraft fuel orders, including the aircraft fuel order, the scheduler being configured to generate an indication in the order interface of a recommended available fuel delivery truck for the aircraft fuel order.

6. The system of claim 5, wherein the scheduler is configured to generate an updated schedule for the set of aircraft fuel orders, the scheduler being configured to generate an indication in the order interface of recommended modification to existing aircraft fuel orders.

7. The system of claim 1, wherein the trained neural network is based on a deep neural network.

8. A method comprising:
receiving and formatting data, in a dataset ingestion operation, from a database, the data including an aircraft fuel order for a fuel delivery from a set of aircraft fuel trucks;
determining, via a trained neural network, predicted wait time value for a set of aircraft fuel trucks based on the aircraft fuel order; and
display, via an order interface for the aircraft fuel order the predicted wait time for the set of aircraft fuel trucks.

9. The method of claim 8 further comprising:
determining, via a geofencing operation, start fueling time and stop fueling time for a given fuel delivery order; and
updating, via a re-training operation, weights of the trained neural network using the start fueling time and stop fueling time.

10. The method of claim 8, wherein the aircraft fuel order includes order information comprising an order time submitted, a requested fuel type, a requested fuel quantity, an aircraft identifier, and a truck GPS location, wherein the order information are provided to an input layer of the trained neural network.

11. The method of claim 8 further comprising:
training a neural network to generate the trained neural network, wherein the training was performed using a training data set comprising a set of transaction, each transaction comprising: order time information, requested fuel type, requested fuel quantity, aircraft identifier, and truck GPS location.

12. The method of claim 8 further comprising:
matching, via a scheduler, an available fuel delivery truck to a set of aircraft fuel orders, including the aircraft fuel order; and
generating, via a user interface, an indication of a recommended available fuel delivery truck for the aircraft fuel order.

13. The method of claim 12, wherein the scheduler is configured to generate an updated schedule for the set of aircraft fuel orders, the scheduler being configured to generate an indication in the order interface of recommended modification to existing aircraft fuel orders.

14. The method of claim 8, wherein the trained neural network is based on a deep neural network.

15. A non-transitory computer readable medium having instructions stored thereon, wherein execution of the instructions by a processor causes the processor to execute:
a dataset ingestion module configured to receive and to format data from a database, including an aircraft fuel order for a fuel delivery;
a trained neural network configured to determine a predicted wait time for a set of aircraft fuel trucks based on the aircraft fuel order; and
an order interface configured to display the predicted wait time for each of the set of aircraft fuel trucks.

16. The computer readable medium of claim 15, wherein execution of the instructions by the processor further causes the processor to execute:
a geofencing analysis module configured to determine start fueling time and stop fueling time for a given fuel delivery order, wherein the start fueling time and stop fueling time are used to update, via a re-training operation, weights of the trained neural network.

17. The computer readable medium of claim 15, wherein the aircraft fuel order includes order information comprising an order time submitted, a requested fuel type, a requested fuel quantity, an aircraft identifier, and a truck GPS location, wherein the order information are provided to an input layer of the trained neural network.

18. The computer readable medium of claim 15, wherein the trained neural network was trained via a training data set comprising a set of transaction, each transaction comprising: order time information, requested fuel type, requested fuel quantity, aircraft identifier, and truck GPS location.

19. The computer readable medium of claim 15, wherein execution of the instructions by the processor further causes the processor to execute:
a scheduler configured to match, via a solver, an available fuel delivery truck to a set of aircraft fuel orders, including the aircraft fuel order, the scheduler being configured to generate an indication in the order interface of a recommended available fuel delivery truck for the aircraft fuel order.

20. The computer readable medium of claim 19, wherein the scheduler is configured to generate an updated schedule for the set of aircraft fuel orders, the scheduler being configured to generate an indication in the order interface of recommended modification to existing aircraft fuel orders.
